(19) United States
(12) Patent Application Publication
(10) Pub. No.: US 2021/0205963 A1
(43) Pub. Date: Jul. 8, 2021

(54) SOCKET REMOVABLY ATTACHED TO A TOOL AND HAVING DRIVING PROTRUSIONS

(71) Applicants: Yao-Lin Cho, Taichung City (TW); Zi-Yan Huang, Taichung City (TW); Chih-Chao Chang, Taichung City (TW)

(72) Inventors: Yao-Lin Cho, Taichung City (TW); Zi-Yan Huang, Taichung City (TW); Chih-Chao Chang, Taichung City (TW)

(21) Appl. No.: 17/207,724

(22) Filed: Mar. 21, 2021

Related U.S. Application Data
(63) Continuation-in-part of application No. 16/587,051, filed on Sep. 30, 2019.
Application No. 16/587,051 is a continuation-in-part of application No. 15/638,369, filed on Jun. 30, 2017, now abandoned.

(51) Int. Cl. B25B 13/06; B25B 23/00; B25B 23/10

(52) U.S. Cl. CPC B25B 13/065; B25B 23/108; B25B 23/0035

(57) ABSTRACT

A socket is portably and removably attached to a tool and includes a body with a mounting hole which includes multiple faces. Each face includes a first protrusion and two groups of second protrusions located on two sides of the first protrusion. The first protrusion of each face includes a first flat distal surface which has a certain length. Each second protrusion includes a second flat distal surface which is tilt relative to the first flat distal surface. The two respective slopes of the second flat distal surfaces of the two groups of the second protrusions are opposite to each other. A first imaginary plane is co-linear with the first flat distal surface. A second imaginary plane is co-linear with the second flat distal surfaces of each second protrusion. An angle is formed between the first and second imaginary planes. The socket can drive a normal or rounded bolt.

### FIELDS OF THE INVENTION

This application is a Continuation-In-Part application of applicant's formal patent application with application Ser. No. 16/587,051, filed on Sep. 30, 2019.

### BACKGROUND OF THE INVENTION

### Descriptions of Related Art

Sockets are provided with a mounting hole which generally is a polygonal hole, the polygonal hole includes multiple faces which are designed to be in contact with sides of a nut or a bolt head. The sockets can be connected with a tool such as a wrench, and when the wrench is rotated, the socket is rotated to loosen the nut or bolt head. However, if the nut or bolt head is rounded or damaged, the faces of the polygonal hole are not in contact with the sides of the nut or bolt head, then the rotation of the socket cannot drive the nut or bolt head.

U.S. Pat. No. 6,851,336 discloses a socket which has a mounting hole with twelve faces which are grouped into six triangular protrusions. Each triangular protrusion includes two faces intersects at a peak. A normal bolt head with six sides are respectively in contact with six of the twelve faces of the mounting hole. However, when a rounded bolt head is to be rotated, the peaks of the triangular protrusions cannot provide sufficient grabbing force to the rounded bolt head.

U.S. Pat. No. 5,148,726 to Huebschen et al. discloses an open-end wrench which includes two jaws with a throat formed between the two jaws so as to form the open-end wrench head. Each jaw includes a driving surface, and the throat includes an arcuate surface. Each driving surface and the arcuate surface includes a first protrusion with a first fat distal surface, and two groups of second protrusions located between the first protrusion.

The open-end wrench disclosed by Huebschen et al. includes a handle that is formed with the open-end wrench, the handle may not be fit in a narrow space to allow the open-end wrench head to access the object. Besides, there are only maximum of four driving sides are available to be in contact with the object for the open-end wrench. That is to say, the object to be loosened with six sides are driven optimally by only four sides thereof by the open-end wrench to Huebschen et al. This may not provide sufficient torque to the object by only four sides of the object to be driven.

U.S. Patent Publication Number 2018/0141192 to Chang discloses a driving portion of a wrench. The driving portion is a circular portion with a mounting hole. Three first driving portions and three second driving portions are formed to the inner periphery of the mounting hole, and are located alternatively from each other. Three first recesses and three second recesses are formed alternatively between the first and second driving portions.

Although Chang discloses a circular driving portion. The disclosure by Chang includes a handle that is formed with the driving portion, again, the handle may not be fit in a narrow space to allow the driving portion to access the object.

The present invention intends to provide a socket that is portable and removably attached to a tool such as a ratchet wrench.

The socket of the present invention includes first and second protrusions in specific shapes protruding from each face of the mounting hole of the socket so as to be securely engaged with a normal or rounded bolt head.

### SUMMARY OF THE INVENTION

The present invention relates to a socket and comprises a body which is a tubular and elongate body and includes a connection section and a driving section which is located co-axially to the connection section. A mounting hole is defined axially through the body. The mounting hole is a first hole in the connection section, and the mounting hole is a second hole in the driving section. The first hole is a rectangular hole, and the second hole is a polygonal hole. The connection section is removably attached to a tool.

The mounting hole includes multiple faces. Each face includes a first protrusion protruding from the central portion thereof. The first protrusion of each face includes a first flat distal surface which has a certain length. Multiple second protrusions protrude from each face of the mounting hole and are arranged into two groups. The first protrusion is located between the two groups of the second protrusions. Each second protrusion includes a second flat distal surface which has a certain length and is tilt relative to the first flat distal surface. The slope of each of the second flat distal surfaces of the second protrusions of each group is identical. The two respective slopes of the second flat distal surfaces of the two groups of the second protrusions are opposite to each other. A first imaginary plane is co-linear with the first flat distal surface. A second imaginary plane is co-linear with the second flat distal surfaces of each group of the second protrusions. An angle is defined between the first imaginary plane and each of the second imaginary planes.

Preferably, the angle is larger than 0 degree, and the maximum value of the angle is 5 degrees.

Preferably, the angle is 2 degrees

Preferably, a groove is defined axially between adjacent faces of the mounting hole.

Preferably, a triangular notch is defined axially between adjacent second protrusions.

Preferably, the length of each second flat distal surface is longer than the length of each first flat distal surface.

Preferably, the length of each second flat distal surface is 0.56 mm, and the length of each first flat distal surface is 0.5 mm.

The primary object of the present invention is to provide a socket that is portable and removably attached to a tool. The socket is able to be securely mounted to a rounded or damaged nut or bolt head, and is able to loosen the rounded or damaged nut or bolt head.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the socket of the present invention;

FIG. 2 is a top view to show the socket of the present invention;

FIG. 3 is an enlarged view to show each face of the mounting hole of the socket of the present invention;

FIG. 4 shows the socket of the present invention, a wrench and a normal bolt;

FIG. 5 shows that the bolt is accommodated in the mounting hole of the socket of the present invention;

FIG. 6 shows the socket of the present invention, a wrench and a rounded bolt;

FIG. 7 shows that the rounded bolt is accommodated in the mounting hole of the socket of the present invention;

FIG. 8 shows that the socket is rotated, and the second protrusions of the socket of the present invention are engaged with the rounded bolt, and

FIG. 9 is an enlarged view to show each face of the mounting hole of the socket of the present invention and the rounded bolt.

### DETAILED DESCRIPTION OF THE PREFERRED EMBODIMENT

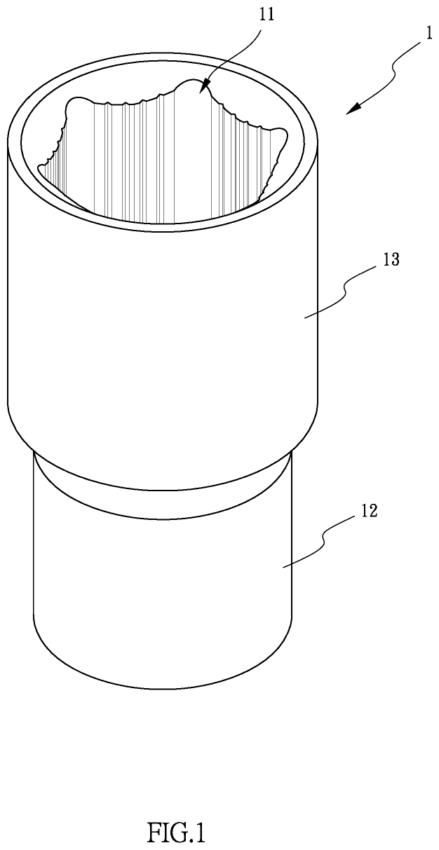

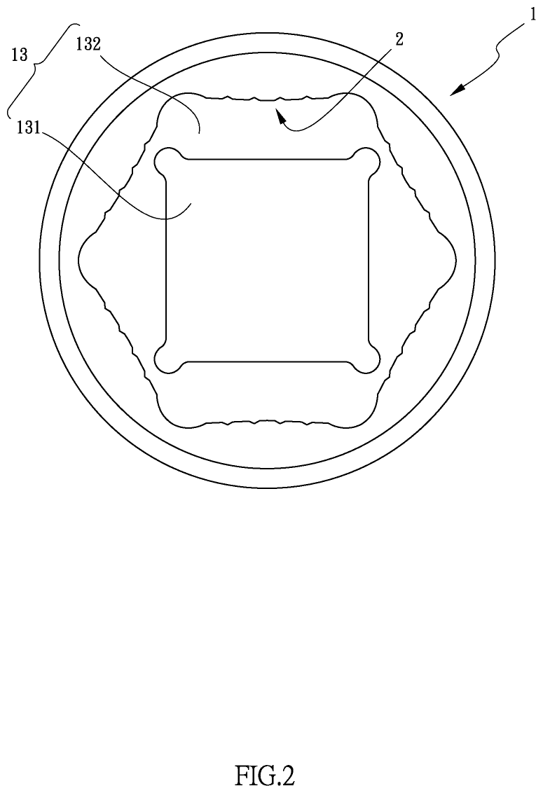

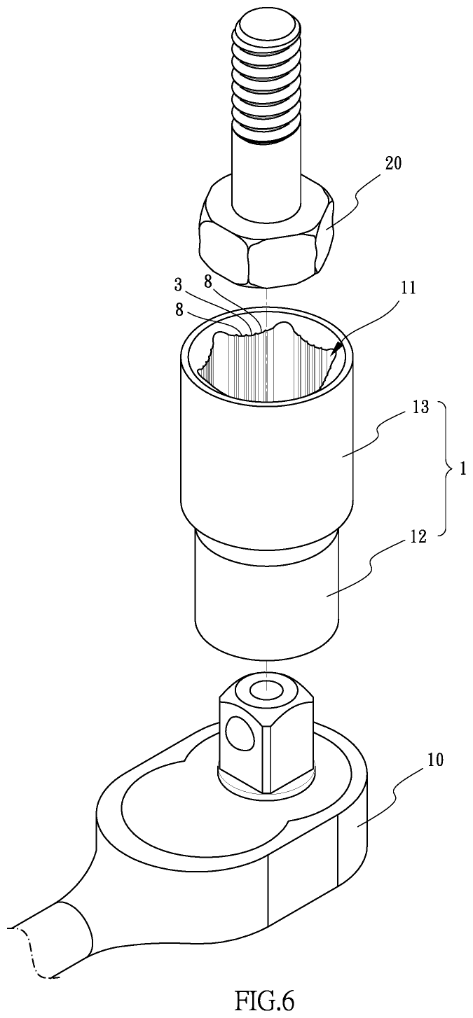

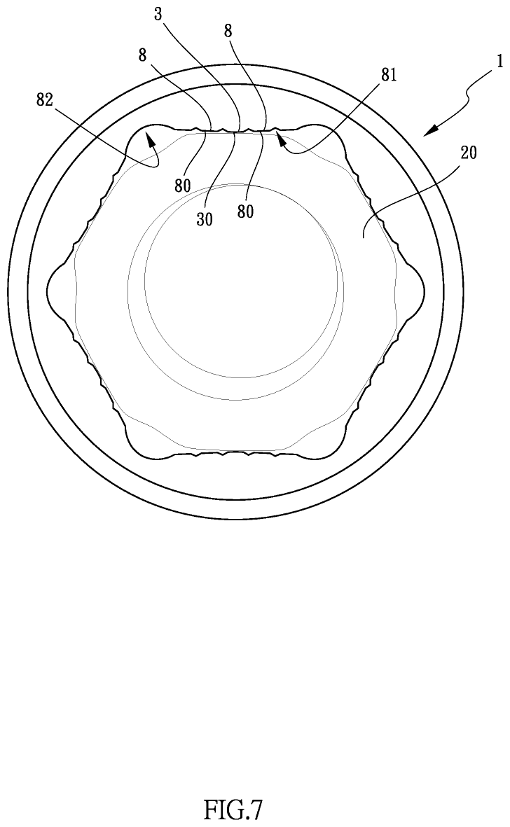

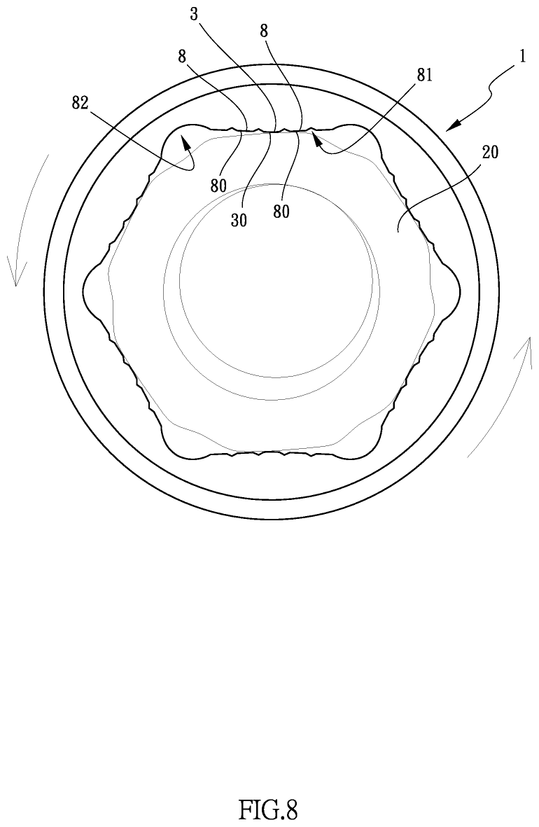

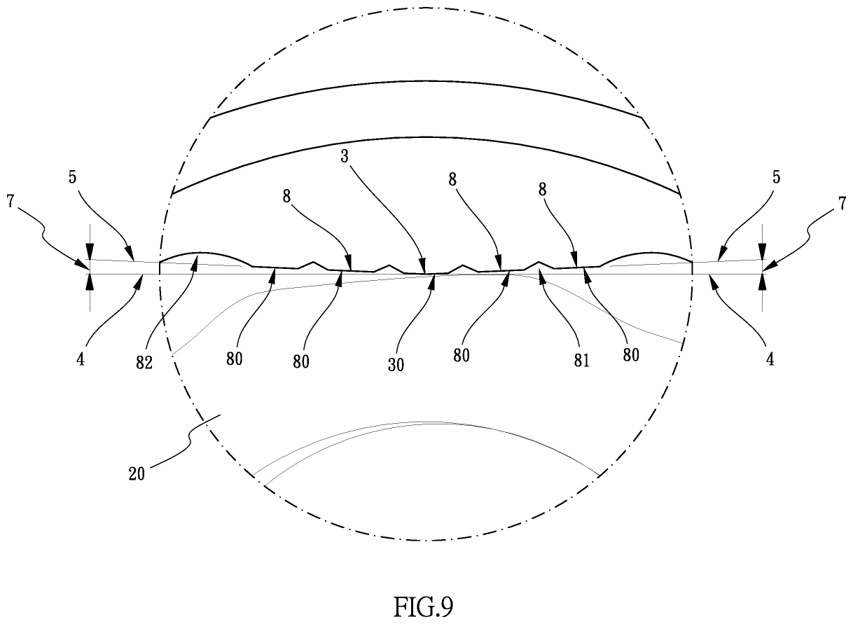

Referring to FIGS. 1 to 9, the socket 1 of the present invention is cooperated with a wrench 10 to loosen a bolt 20. The socket 1 comprises a body with a mounting hole 11 defined axially therethrough. The body is a tubular and elongate body. The body includes a connection section 12 and a driving section 13 which is located co-axially to the connection section 12. A mounting hole 11 is defined axially through the body. The mounting hole 11 is a first hole 131 in the connection section 12, and the mounting hole 11 is a second hole 132 in the driving section 13. The first hole is a rectangular hole, the second hole 132 is a polygonal hole. The connection section 12 is portable and removably attached to a tool such as a ratchet wrench. The driving section 13 is to be mounted to the bolt 20.

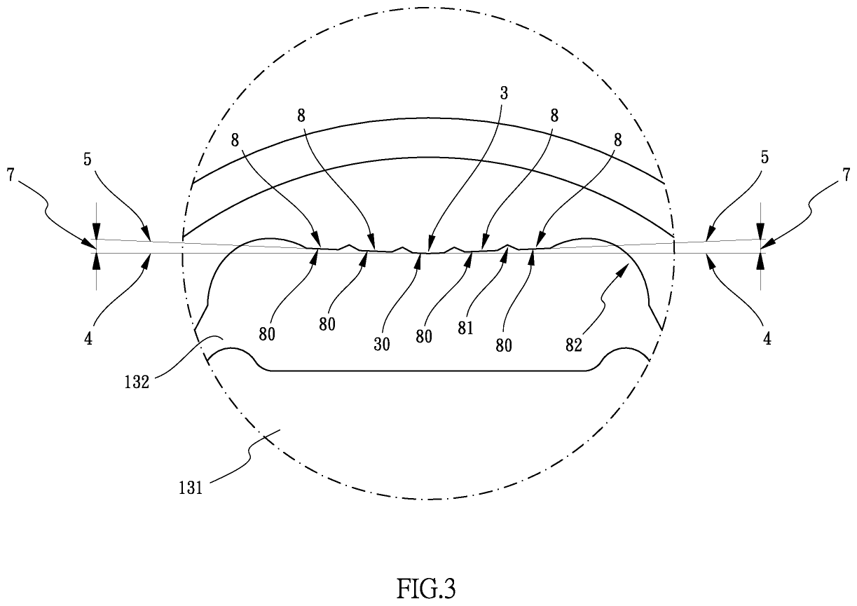

As shown in FIG. 3, the mounting hole 11 in the driving section 13 includes six faces 2, and each face 2 comprises a first protrusion 3 protruding from the central portion thereof. The first protrusion 3 of each face 2 includes a first flat distal surface 30 which has a certain length. A first imaginary plane 4 is co-linear with the first flat distal surface 30. Multiple second protrusions 8 protrude from each face 2 of the mounting hole 11 and are arranged into two groups. The first protrusion 3 is located between the two groups of the second protrusions 8. In this embodiment, each group of the second protrusions 8 includes two second protrusions 8. A triangular notch 81 is defined axially between the two adjacent second protrusions 8 of each group of the second protrusions 8. Each second protrusion 8 includes a second flat distal surface 80 which has a certain length and is tilt relative to the first flat distal surface 30. Specifically, the slope of each of the two second flat distal surfaces 80 of the two second protrusions 8 of each group is identical. The two respective slopes of the second flat distal surface 80 of the two groups of the second protrusions 8 are opposite to each other.

A second imaginary plane 5 is co-linear with the two second flat distal surfaces 80 of each group of the second protrusions 8. An angle 7 is defined between the first imaginary plane 4 and each of the second imaginary planes 5. The angle 7 is larger than 0 degree, and the maximum value of the angle 7 is 5 degrees. Preferably, the angle 7 is 2 degrees.

A curved groove 82 is defined axially between any of the adjacent faces 2 of the mounting hole 11.

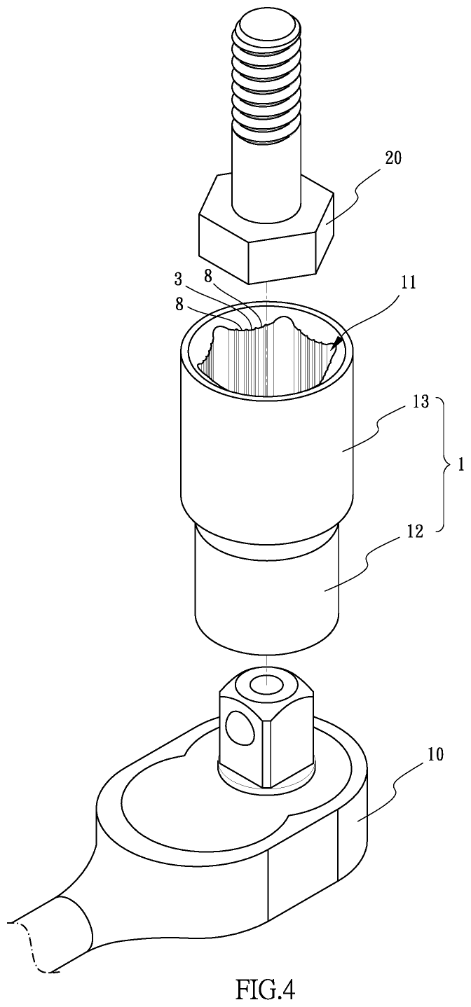

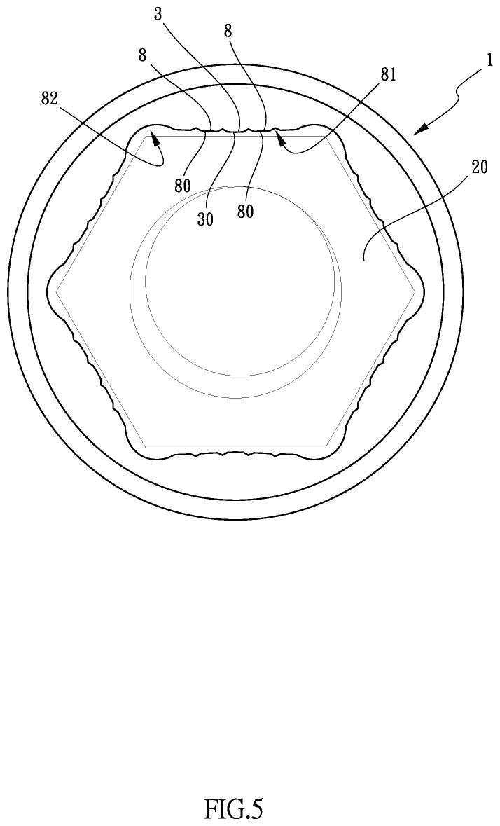

As shown in FIGS. 4 and 5, when loosening a normal bolt 20, the six sides of the head of the bolt 20 are in contact with the faces 2 of the mounting hole 11. When rotating the wrench 10, the socket 1 is rotated to rotate the bolt 20.

As shown in FIGS. 5 to 9, when loosening a rounded or damaged bolt 20, the second flat distal surfaces 80 of the second protrusions 8 are at least partially in contact with the six sides of the head of the bolt 20 so that when rotating the wrench 10, the socket 1 is rotated to rotate the bolt 20.

One of the embodiments of the socket 1 is described hereinafter, wherein the length of each face 2 is 55 mm, and the width of each notch 81 is 0.38 mm and the depth of each notch 81 is 0.1 mm. The length of each second flat distal surface 80 is 0.56 mm, and the length of each first flat distal surface 30 is 0.5 mm. The socket 1 of the present invention can effectively rotate normal or rounded/damaged nut or bolt.

While we have shown and described the embodiment in accordance with the present invention, it should be clear to those skilled in the art that further embodiments may be made without departing from the scope of the present invention.

What is claimed is:

1. A socket (1) comprising:
a body being a tubular and elongate body, the body including a connection section (12) and a driving section (13) which is located co-axially to the connection section (12), a mounting hole (11) defined axially through the body, the mounting hole (11) being a first hole (131) in the connection section (12), the mounting hole (11) being a second hole (132) in the driving section (13), the first hole being a rectangular hole, the second hole (132) being a polygonal hole, the connection section (12) adapted to be removably attached to a tool, the mounting hole (11) in the driving section (13) including six faces (2), each face (2) comprising a first protrusion (3) protruding from a central portion thereof, the first protrusion (3) of each face (2) including a first flat distal surface (30) which has a certain length, multiple second protrusions (8) protruding from each face (2) of the mounting hole (11) and being arranged into two groups, the first protrusion (3) located between the two groups of the second protrusions (8), each second protrusion (8) including a second flat distal surface (80) which has a certain length and is tilt relative to the first flat distal surface (30), a slope of each of the second flat distal surfaces (80) of the second protrusions (8) of each group being identical, the two respective slopes of the second flat distal surfaces (80) of the two groups of the second protrusions (8) being opposite to each other, and
a first imaginary plane (4) being co-linear with the first flat distal surface (30), a second imaginary plane (5) being co-linear with the second flat distal surfaces (80) of each group of the second protrusions (8), an angle (7) defined between the first imaginary plane (4) and each of the second imaginary planes (5).

2. The socket as claimed in claim 1, wherein the angle (7) is larger than 0 degree, a maximum value of the angle (7) is 5 degrees.

3. The socket as claimed in claim 1, wherein the angle (7) is 2 degrees

4. The socket as claimed in claim 1, wherein a groove (82) is defined axially between adjacent faces (2) of the mounting hole (11).

5. The socket as claimed in claim 1, wherein a triangular notch (81) is defined axially between the adjacent second protrusions (8) of each group of the second protrusions (8).

6. The socket as claimed in claim 1, wherein a length of each second flat distal surface (80) is longer than a length of each first flat distal surface (30).

7. The socket as claimed in claim 6, wherein the length of each second flat distal surface (80) is 0.56 mm, and the length of each first flat distal surface (30) is 0.5 mm.
